(19) United States
(12) Patent Application Publication
(10) Pub. No.: US 2025/0103252 A1
(43) Pub. Date: Mar. 27, 2025

(54) IMAGE FORMING APPARATUS CAPABLE OF DISPLAYING METHOD OF PROPERLY SETTING SHEET ON SHEET TRAY, METHOD OF CONTROLLING IMAGE FORMING APPARATUS, AND STORAGE MEDIUM

(71) Applicant: CANON KABUSHIKI KAISHA, Tokyo (JP)

(72) Inventor: Eri Okuda, Ibaraki (JP)

(21) Appl. No.: 18/885,916

(22) Filed: Sep. 16, 2024

(30) Foreign Application Priority Data
Sep. 21, 2023 (JP) 2023-155923

(51) Int. Cl. G06F 3/12; G06K 15/00; G06K 15/16

(52) U.S. Cl. CPC G06F 3/1205; G06F 3/1252; G06K 15/16; G06K 15/4065

(57) ABSTRACT

An image forming apparatus that stores sheet information in which setting methods enabling setting of a sheet tray are associated with each sheet tray for a specific sheet which can be set on a sheet tray by methods. A sheet size of a sheet which can be set on a sheet tray designated by a print, the sheet size being a sheet size designated by the print job, is set for the sheet tray designated by the print job. If the sheet size set for the designated sheet tray is a sheet size of the specific sheet, a guidance about a setting method enabling setting of a sheet of the designated sheet size on the designated sheet tray is displayed based on the sheet size set for the designated sheet tray and the sheet information.

### BACKGROUND OF THE INVENTION

### Field of the Invention

The present invention relates to an image forming apparatus that is capable of displaying a method of properly setting a sheet on a sheet tray, a method of controlling the image forming apparatus, and a storage medium.

### Description of the Related Art

In Japanese Laid-Open Patent Publication (Kokai) NO. 2015-38776, there has been proposed a technique that causes a user to set print information for an image forming apparatus in advance, which is to be used when causing the image forming apparatus to print an image on an envelope, and thereby makes it possible to make an orientation of a non-regular envelope and an orientation of an image to be printed on this envelope coincide with each other with high accuracy. Specifically, in the technique proposed in Japanese Laid-Open Patent Publication (Kokai) NO. 2015-38776, as the print information concerning a desired envelope on which a user desires to print an image, a size of the envelope, a flap position, and opening/closing information on the flap are set in advance, whereby the image forming apparatus rotates the image according to the set print information when the image is printed on the envelope. Further, the image forming apparatus presents a proper setting orientation of a sheet on a sheet tray and the like to the user via displaying means, such as a user interface (UI). With this, even when a sheet which is liable to be erroneously set, such as an envelope, is used, the user can easily and correctly set the sheet.

However, depending on the image forming apparatus, for example, there is a case where a combination of the position and the opened/closed state of a flap of an envelope which can be set for the image forming apparatus is limited. In this case, when a user is prompted to set the print information in advance, if the position and the opened/closed state of the flap of the envelope, which are assumed by the user, cannot be used, the setting of a different combination of the position and the opened/closed state of the flap is required again for the same envelope.

### SUMMARY OF THE INVENTION

The present invention provides an image forming apparatus that is capable of properly displaying, for a specific sheet which can be set on the sheet tray by a plurality of methods, a setting method which makes it possible to set the sheet on a sheet tray designated by a print job, a method of controlling the image forming apparatus, and a storage medium.

In a first aspect of the present invention, there is provided an image forming apparatus that stores sheet information in which setting methods are associated with each sheet tray, wherein a sheet corresponding to the sheet information is a specific sheet which can be set on a sheet tray by a plurality of methods, including at least one processor, and a memory coupled to the at least one processor storing instructions that, when executed by the processor, cause the processor to function as: a setting unit configured to set a sheet size for the sheet tray designated by a print job, wherein the sheet size of a sheet which can be set on the sheet tray designated by the print job is a sheet size designated by the print job, and a display unit configured to display, in a case where a specific sheet size of the specific sheet is designated by the print job, a guidance about a setting method which makes it possible to set the specific sheet of the specific sheet size on the sheet tray designated by the print job, based on the specific sheet size and the sheet information.

In a second aspect of the present invention, there is provided a method of controlling an image forming apparatus that stores sheet information in which setting methods are associated with each sheet tray, wherein a sheet corresponding to the sheet information is a specific sheet which can be set on a sheet tray by a plurality of methods, including setting a sheet size for the sheet tray designated by a print job, wherein the sheet size of a sheet which can be set on the sheet tray designated by the print job is a sheet size designated by the print job, and displaying, in a case where a specific sheet size of the specific sheet is designated by the print job, a guidance about a setting method which makes it possible to set the specific sheet of the specific sheet size on the sheet tray designated by the print job, based on the specific sheet size and the sheet information.

According to the present invention, it is possible to properly display, for a specific sheet which can be set on the sheet tray by a plurality of methods, a setting method which makes it possible to set the sheet on a sheet tray designated by a print job.

Further features of the present invention will become apparent from the following description of exemplary embodiments (with reference to the attached drawings).

### BRIEF DESCRIPTION OF THE DRAWINGS

FIG. 1 is a block diagram showing the entire configuration of an image forming apparatus.

FIG. 2 is a block diagram showing the detailed configuration of a controller of the image forming apparatus.

FIG. 3 is a diagram showing a network configuration.

FIGS. 4A and 4B are diagrams each showing setting methods of envelopes which can be set on sheet trays of the image forming apparatus.

FIG. 5 is a flowchart of a process performed by the image forming apparatus, for displaying a setting method guidance for an envelope when a user sets a sheet size for a sheet tray of the image forming apparatus.

FIG. 6A is a diagram showing a sheet tray selection screen as an example of a UI display in a case where the setting method guidance for an envelope is displayed on a console section at the time of sheet tray setting.

FIG. 6B is a diagram showing a sheet size selection screen as an example of a UI display in a case where the setting method guidance for an envelope is displayed on the console section at the time of sheet tray setting.

FIG. 6C is a diagram showing an envelope size selection screen as an example of a UI display in a case where the setting method guidance for an envelope is displayed on the console section at the time of sheet tray setting.

FIG. 6D is a diagram showing a regular size selection screen as an example of a UI display in a case where the setting method guidance for an envelope is displayed on the console section at the time of sheet tray setting.

FIG. 6E is a diagram showing an envelope setting method guidance screen as an example of a UI display in a case where the setting method guidance for an envelope is displayed on the console section at the time of sheet tray setting.

FIG. 7 is a flowchart of a process performed when the image forming apparatus displays the setting method guidance for an envelope in a case where the user sets a sheet during execution of a print job.

FIG. 8 is a diagram showing a sheet setting request screen as an example of a UI display in a case where the setting method guidance for an envelope is displayed on the console section during execution of a print job.

### DESCRIPTION OF THE EMBODIMENTS

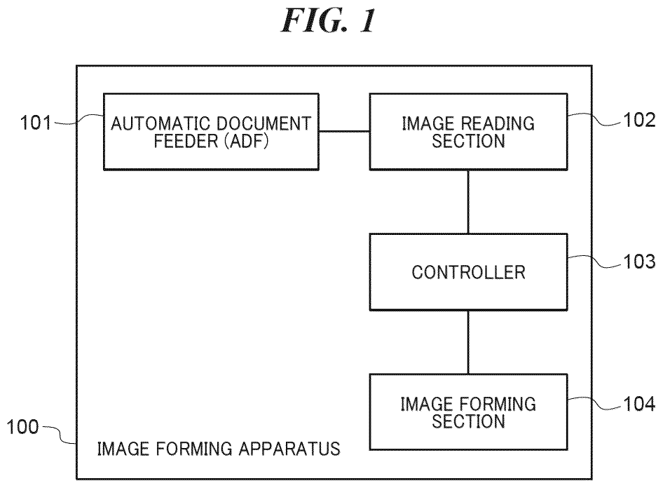

The present invention will now be described in detail below with reference to the accompanying drawings showing embodiments thereof. However, the component elements described in the following embodiment are described only by way of example, and are by no means intended to limit the scope of the present invention to them alone. For example, components of the present invention can be each replaced by a desired component which can exhibit the same function. Further, a desired component can be added. Furter, two or more desired configurations (features) of the embodiments can be combined. An image forming apparatus of the present invention can be applied to a multi-function peripheral (MFP), a printer, an image forming apparatus that forms an image on a sheet by the electrophotographic method or the like, by way of example, but in the present embodiment, the multi-function peripheral (hereinafter referred to as the “image forming apparatus”) will be described. Note that the multi-function peripheral refers to an apparatus having at least two or more functions of a plurality of types of functions, including e.g. a print function, a scan function, a copy function, and a facsimile function. The present embodiment will be described below with reference to FIGS. 1 to 8.

FIG. 1 is a block diagram showing the entire configuration of an image forming apparatus 100 according to the present embodiment. As shown in FIG. 1, the image forming apparatus 100 includes an automatic document feeder (ADF) 101, an image reading section 102, a controller 103, and an image forming section 104. The ADF 101 sends and receives a control signal to and from the image reading section 102 via a data bus, conveys an original, and notifies the image reading section 102 of values of a variety of sensors including an original detection sensor. The image reading section 102 operates in cooperation with the ADF 101 to read an original according to an original reading instruction received from the controller 103 via the data bus. The controller 103 controls the overall operation of the image forming apparatus 100 including the ADF 101, the image reading section 102, and the image forming section 104 via the data bus, analyzes input image data, and appropriately performs image processing on the image data to generate image data to be output. The image forming section 104 conveys a sheet, prints the image data acquired from the controller 103 via the data bus on the conveyed sheet as a visible image, and discharges the printed sheet out of the image forming apparatus. 100

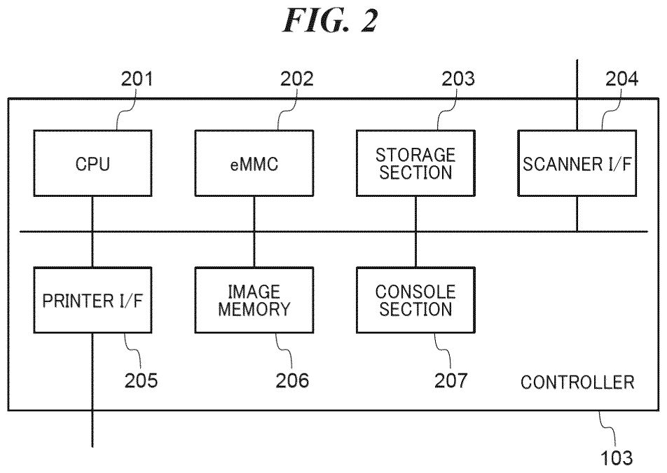

FIG. 2 is a block diagram showing the detailed configuration of the controller 103 of the image forming apparatus 100. In the following description, the detailed configuration of the controller 103 will be described with reference to FIG. 2. The controller 103 includes a central processing unit (CPU) 201, an embedded Multi Media Card (eMMC) 202, a storage section 203, a scanner interface (I/F) 204, a printer I/F 205, an image memory 206, and a console section 207. The CPU 201 controls the overall operation of the image forming apparatus 100. The eMMC 202 is implemented by a flash memory storing control programs of the CPU 201. The storage section 203 is a nonvolatile memory for storing information necessary for a variety of controls. The scanner I/F 204 sends and receives data to and from the image reading section 102. The printer I/F 205 sends and receives data to and from the image forming section 104. In the image memory 206, image data acquired via the scanner I/F 204 is stored. The console section 207 has a touch panel and hard keys for presenting information to a user and receiving operations for inputting a job and performing a variety of settings.

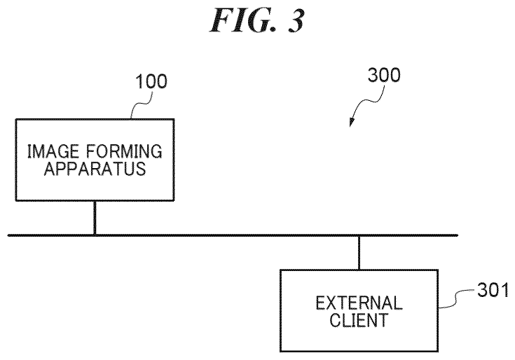

FIG. 3 is a diagram showing a configuration of a network 300. The image forming apparatus 100 is connected to an external client 301 via the network 300 as shown in FIG. 3. The external client 301 has an application which can input a remote job to the image forming apparatus 100. Note that the external client 301 and the application can be a personal computer (PC) and a driver application of the image forming apparatus 100, respectively, or can be a smartphone and a mobile application compatible with the image forming apparatus 100, respectively.

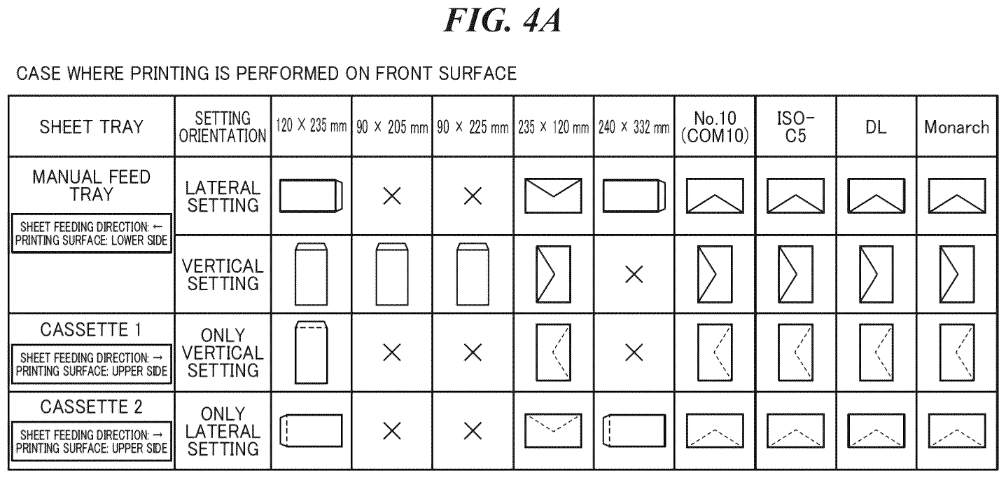

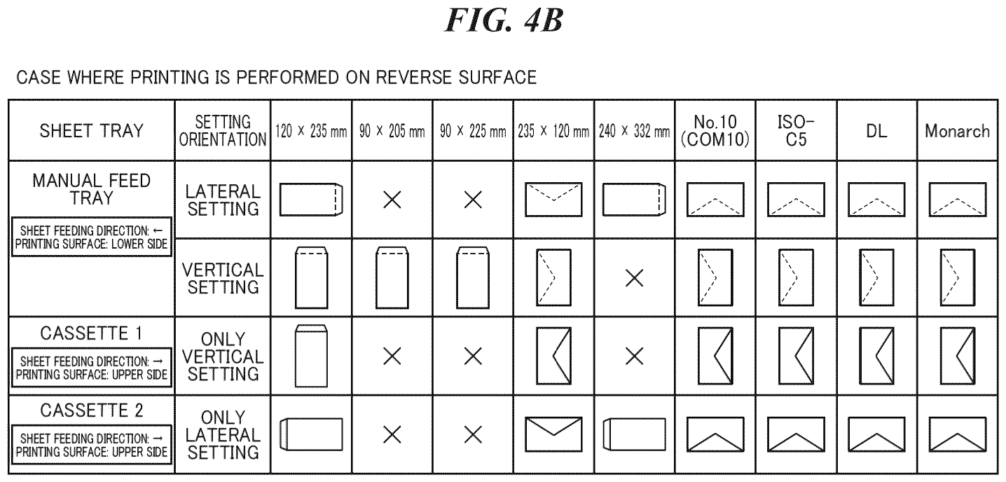

FIGS. 4A and 4B are diagrams showing setting methods of

envelopes which can be set on sheet trays of the image forming apparatus 100. FIG. 4A is a diagram showing setting methods of envelopes which can be set on the sheet trays of the image forming apparatus 100 in a case where the image forming apparatus 100 performs printing on a front surface of each envelope. FIG. 4B is a diagram showing setting methods of envelopes which can be set on the sheet trays of the image forming apparatus 100 in a case where the image forming apparatus 100 performs printing on a reverse surface of each envelope. Here, a surface on which an address is generally written is defined as the front surface, and a surface opposite to the front surface is defined as the reverse surface. The image forming apparatus 100 has a manual feed tray, a cassette 1, and a cassette 2, as the three sheet trays. In the present embodiment, when a sheet is set on the sheet tray, the sheet is fed toward the left side when the manual feed tray is used and fed toward the right side when the cassettes 1 and 2 are used, as viewed from the right above. Further, when the manual feed tray is used, printing is performed on a lower surface of the sheet, and when the cassettes 1 and 2 are used, printing is performed on an upper surface of the sheet.

Note that the envelope is one of specific sheets which are set on the sheet tray by a plurality of methods. Further, in the storage section 203, the information shown in FIGS. 4A and 4B, i.e. the information on setting methods of envelopes which can be set on the sheet trays of the image forming apparatus 100 is stored as the sheet information in a state associated with each sheet tray. When performing a process for displaying the setting method guidance for an envelope, described hereinafter, the CPU 201 refers to the sheet information (information on a setting method of an envelope which can be set on a sheet tray of the image forming apparatus 100, shown in FIGS. 4A and 4B) stored in the storage section 203 and switches an illustration and an explanatory note, which are displayed on the console section 207.

Differences in the setting methods of envelopes which can be set, between sheet trays, as shown in FIGS. 4A and 4B, are generally generated by differences in a sheet conveying path due to a position of each sheet tray, differences in a sheet setting guide device (device for fixing a sheet position placed on the sheet tray) included in each sheet tray, and so forth. Therefore, in the image forming apparatus 100, when a user desires to perform printing on an envelope, the user is required to set the envelope on the sheet tray by a proper method according to the size of an envelope on which printing is desired to be performed, a surface on which printing is desired to be performed, and a sheet tray desired to use. Based on the above, the process performed by the image forming apparatus 100 for displaying the setting method guidance for an envelope will be described with reference to a flowchart.

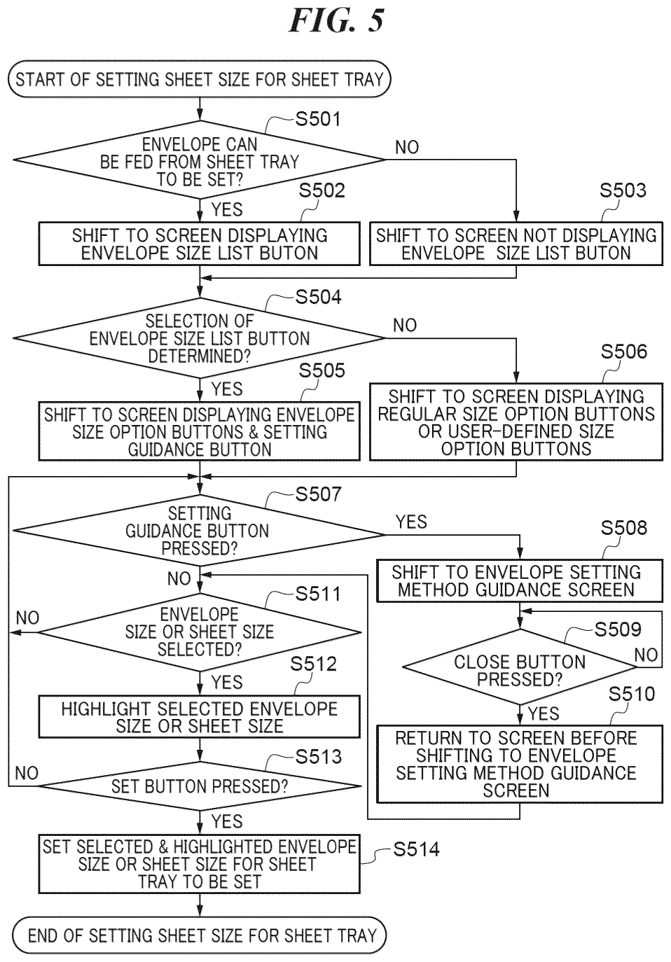

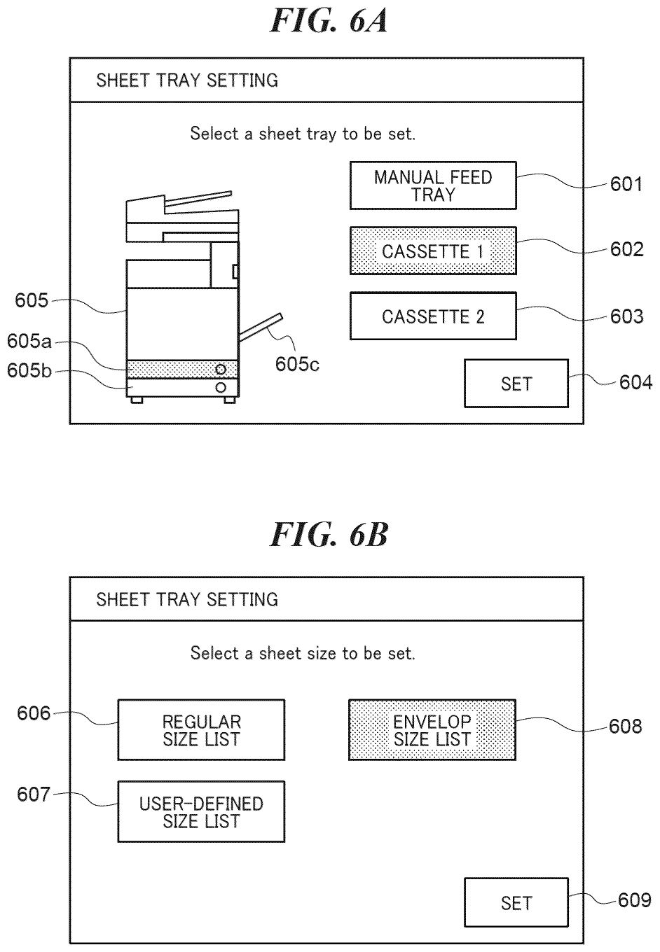

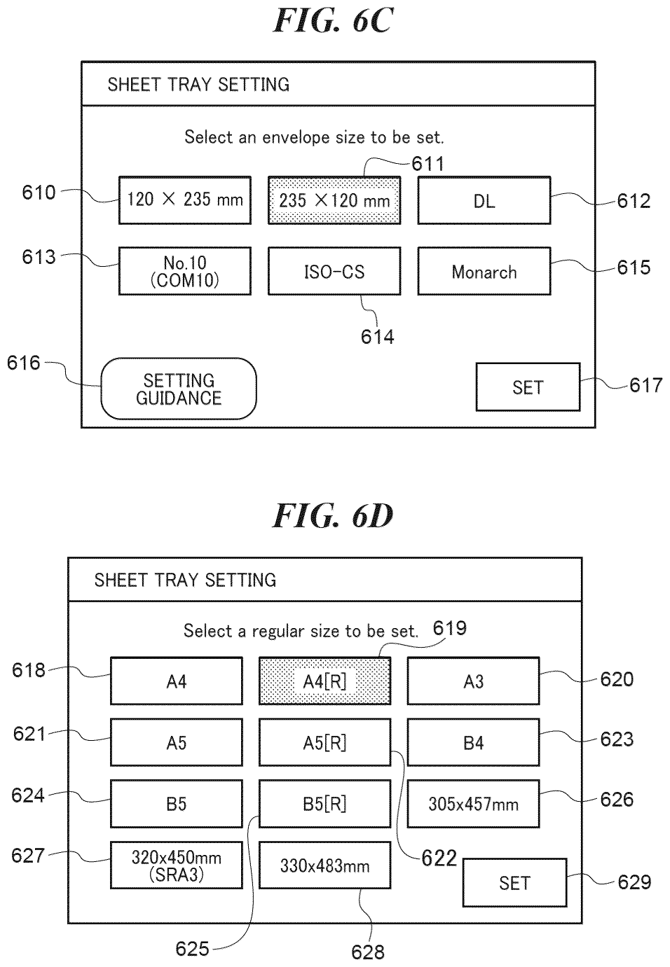

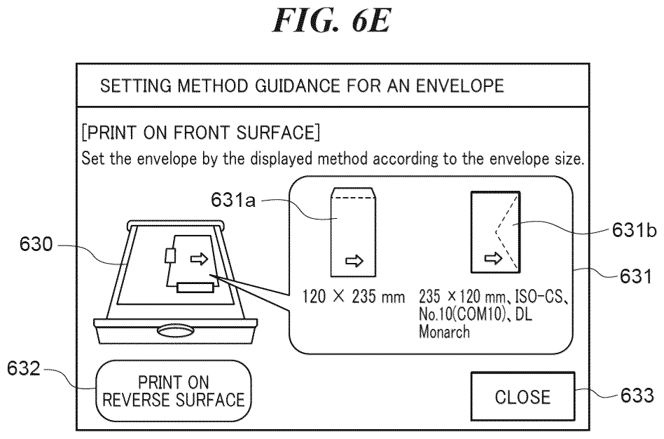

FIG. 5 is a flowchart of the process performed by the image forming apparatus 100 for displaying the setting method guidance for an envelope, when the user sets a sheet size for a sheet tray of the image forming apparatus 100 (hereinafter referred to as “at the time of sheet tray setting”). The process performed by the image forming apparatus 100, shown in FIG. 5, is a process performed in a case where the user sets a sheet or sheets before a print job is input. Note that the process performed by the image forming apparatus 100, shown in FIG. 5, is realized by the CPU 201 that loads a program stored in the storage section 203 into the eMMC 202 and executes the loaded program. The process performed by the image forming apparatus 100 for displaying the setting method guidance for an envelope at the time of sheet tray setting), shown in FIG. 5, will be described below with reference to FIGS. 6A to 6E.

FIGS. 6A to 6E are diagrams each showing an example of a UI display in a case where the setting method guidance for an envelope is displayed on the console section 207 at the time of sheet tray setting. When the setting of a sheet size for the sheet tray is started, a sheet tray selection screen shown in FIG. 6A is displayed on the console section 207. On the sheet tray selection screen shown in FIG. 6A, sheet tray selection buttons 601 to 603, a set button 604, and an illustration 605 are displayed. The sheet tray selection buttons 601 to 603 each receive selection of a sheet tray to be set from the user. The set button 604 finally determines a sheet tray being currently selected as the sheet tray to be set. The illustration 605 indicates the appearance of the image forming apparatus 100. In the illustration 605, the respective positions of the three sheet trays are indicated by illustrations 605a to 605c.

On the sheet tray selection screen shown in FIG. 6A, when the user selects a sheet tray by pressing one of the sheet tray selection buttons 601 to 603, the selected button (hereinafter referred to as the “sheet tray selection button being selected”) of the sheet tray selection buttons 601 to 603 is highlighted. Further, the illustration of one of the illustrations 605a to 605c of the sheet tray, which corresponds to the sheet tray selection button being selected, is highlighted. Note that on the sheet tray selection screen shown in FIG. 6A, the sheet tray selection button 602 as the sheet tray button being selected and the illustration 605a of the sheet tray corresponding to the sheet tray selection button 602 are highlighted. Further, when the user presses the set button 604 in a state in which one of the sheet tray selection buttons 601 to 603 has been selected, the sheet tray corresponding to the sheet tray selection button being selected is finally determined as the object to be set. Note that in the following description, a sheet tray of the three sheet trays, which is finally determined as the object to be set, is denoted as the “sheet tray to be set”.

Thus, when the setting of the sheet size for the sheet tray is started, as shown in FIG. 5, in a step S501, the CPU 201 determines whether or not an envelope can be fed from the sheet tray to be set. This determination is performed by the CPU 201 that refers to the sheet information stored in the storage section 203 and confirms whether or not there is the information on a setting method of an envelope which can be set and is associated with the sheet tray to be set. If it is determined by the CPU 201 that an envelope can be fed from the sheet tray to be set, the process proceeds to a step S502. On the other hand, if it is determined by the CPU 201 that an envelope cannot be fed from the sheet tray to be set, the process proceeds to a step S503.

Note that in the present embodiment, as shown in FIGS. 4A and 4B, the information on setting methods of envelopes which can be set exists with respect to all of the sheet trays. However, for example, in a case where a cassette 3 as a new sheet tray is added, if the cassette 3 is a sheet tray from which envelopes cannot be fed, the information on setting methods of envelopes which can be set and are associated with the cassette 3, is not included in the sheet information stored in the storage section 203. Therefore, in this case, it is determined that envelopes cannot be fed from the sheet tray to be set.

In the step S502, the CPU 201 shifts the sheet tray selection screen shown in FIG. 6A to a sheet size selection screen shown in FIG. 6B on the console section 207. On the sheet size selection screen shown in FIG. 6B, a regular size list button 606, a user-defined size list button 607, and an envelope size list button 608 are displayed as options of the sheet size. Further, on the sheet size selection screen shown in FIG. 6B, a set button 609 is displayed. In the step S502, further, the CPU 201 highlights one, pressed and selected by the user, of the regular size list button 606, the user-defined size list button 607, and the envelope size list button 608. Note that FIG. 6B is a diagram showing the sheet size selection screen on which the envelope size list button 608 is highlighted.

In the step S503, the CPU 201 shifts the sheet tray selection screen shown in FIG. 6A to the sheet size selection screen shown in FIG. 6B on the console section 207. However, in this case, as the options of the sheet size, although the regular size list button 606 and the user-defined size list button 607 are displayed, the envelope size list button 608 is not displayed. In the step S503, further, the CPU 201 highlights one, pressed and selected by the user, of the regular size list button 606 and the user-defined size list button 607.

In a step S504, the CPU 201 determines whether or not selection of the envelope size list button 608 has been finally determined. When the user presses the set button 609 in a state in which the envelope size list button 608 has been selected by the user's pressing operation on the sheet size selection screen shown in FIG. 6B, the CPU 201 determines that selection of the envelope size list button 608 has been finally determined. After that, the process proceeds to a step S505. On the other hand, if it is determined by the CPU 201 that selection of the envelope size list button 608 has not been finally determined, the process proceeds to a step S506. Note that the case where it is determined that selection of the envelope size list button 608 has not been finally determined incudes a case where the user presses the set button 609 in a state in which the regular size list button 606 or the user-defined size list button 607 has been selected.

In the step S505, the CPU 201 shifts the sheet size selection screen shown in FIG. 6B to an envelope size selection screen shown in FIG. 6C on the console section 207. On the envelope size selection screen shown in FIG. 6C, envelope size option buttons 610 to 615, a setting guidance button 616, and a set button 617 are displayed. Each of the envelope size option buttons 610 to 615 indicates one of the envelope sizes which can be set on the sheet tray to be set.

In the step S506, the CPU 201 shifts the sheet size selection screen shown in FIG. 6B to a regular size selection screen shown in FIG. 6D or a user-defined size selection screen, not shown, on the console section 207. However, on the regular size selection screen shown in FIG. 6D and the user-defined size selection screen, not shown, the above-mentioned setting guidance button 616 is not displayed. Specifically, on the regular size selection screen shown in FIG. 6D, regular size option buttons 618 to 628 and a set button 629 are displayed, but the setting guidance button 616 is not displayed.

Further, similar to the regular size selection screen shown in FIG. 6D, on the user-defined size selection screen, not shown, user-defined size option buttons and a set button are displayed, but the setting guidance button 616 is not displayed. Therefore, in the process after the step S506, the setting guidance button 616 is not displayed. For this reason, the process after the step S506 is the same as the process after the step S505 except that determination of the question of a step S507, described hereinafter, is negative (NO), necessarily causes the process to proceed to a step S511, described hereinafter. Therefore, description of processing operations after the step S506 is omitted.

In the step S507, the CPU 201 determines whether or not the setting guidance button 616 has been pressed. When the user presses the setting guidance button 616 on the envelope size selection screen shown in FIG. 6C, the CPU 201 determines that the setting guidance button 616 has been pressed. If it is determined by the CPU 201 that the setting guidance button 616 has been pressed, the process proceeds to a step S508. On the other hand, if it is determined by the CPU 201 that the setting guidance button 616 has not been pressed, the process proceeds to the step S511.

In the step S508, the CPU 201 shifts the envelope size selection screen shown in FIG. 6C to an envelope setting method guidance screen shown in FIG. 6E on the console section 207. On the envelope setting method guidance screen shown in FIG. 6E, an illustration 630 of the sheet tray to be set, and a speech balloon 631 for explaining how to set an envelope which can be set on the sheet tray to be set are displayed. Further, on the envelope setting method guidance screen shown in FIG. 6E, a reverse surface printing button 632 and a close button 633 are displayed.

Further, the CPU 201 refers to the sheet information (information on setting methods of envelopes which can be set on the sheet trays of the image forming apparatus 100, shown in FIGS. 4A and 4B) stored in the storage section 203 and determines the explanation contents indicated in the speech balloon 631. The explanation contents indicated in the speech balloon 631 can be presented by illustrations, such as illustrations 631a and 631b or can be each presented by a sentence or a combination of a sentence and an illustration. Note that the explanation contents presented in the speech balloon 631 include information for making it possible to determine whether or not the envelope is properly set by the user with respect to each of a case where the user desires to perform printing on the front surface and a case where the user desires to perform printing on the reverse surface. The information includes information on a position of a flap (whether the flap is at a long side or a short side of the envelope), an opened/closed state of the flap, information on which of the reverse surface and the front surface of the envelope faces upward, information on which side of the envelope is the leading edge side in the conveying direction, and so forth. Here, as mentioned above, a surface on which an address is generally written is defined as the front surface, and a surface opposite to the front surface is defined as the reverse surface.

Further, the CPU 201 can switch the envelope setting method guidance screen shown in FIG. 6E to a guidance screen for the front surface or a guidance screen for the reverse surface, depending on whether the user desires to perform printing on the front surface or the reverse surface. In this case, a button for switching the printing surface, such as the reverse surface printing button 632, is made available, and the CPU 201 switches the envelope setting method guidance screen to the envelope setting method guidance screen for the front surface or the envelope setting method guidance screen for the reverse surface according to an input from the user using this button. Incidentally, since the envelope setting method guidance screen shown in FIG. 6E includes the reverse surface printing button 632, the envelope setting method guidance screen 632 is the envelope setting method guidance screen for the front surface.

Further, a case can be considered where a plurality of setting methods, such as “vertical setting” and “lateral setting”, are provided with respect to an envelope set for the same sheet tray, as provided for the manual feed tray in the present embodiment (see FIGS. 4A and 4B). It is necessary to present the setting methods of “vertical setting” and “lateral setting” to the user with respect to this sheet tray. To present the setting methods of “vertical setting” and “lateral setting” to the user, the CPU 201 can display the setting methods of “vertical setting” and “lateral setting”, side by side, on the same envelope setting method guidance screen. Further, a button for switching between the displays of “vertical setting” and “lateral setting” can be made available, and the CPU 201 can switch between an envelope setting method guidance screen for “vertical setting” and an envelope setting method guidance screen for “lateral setting”, according to an input of the user using this button. The user can easily set the envelope, by setting the envelope on a desired sheet tray by a correct method, while referring to the envelope setting method guidance screen shown in FIG. 6E.

In a step S509, the CPU 201 determines whether or not the close button 633 has been pressed. When the user presses the close button 633 on the envelope setting method guidance screen shown in FIG. 6E, the CPU 201 determines that the close button 633 has been pressed. If it is determined by the CPU 201 that the close button 633 has been pressed, the process proceeds to a step S510. On the other hand, if it is determined by the CPU 201 that the close button 633 has not been pressed, the process returns to the step S509. In the step S510, the CPU 201 returns the envelope setting method guidance screen shown in FIG. 6E to the screen before the shift, i.e. to the envelope size selection screen shown in FIG. 6C. Therefore, unless the close button 633 is pressed by the user on the envelope setting method guidance screen shown in FIG. 6E, the CPU 201 maintains a state in which the envelope setting method guidance screen shown in FIG. 6E is displayed.

In the step S511, the CPU 201 determines whether or not an envelope size has been selected. When one of the envelope size option buttons 610 to 615 is pressed by the user on the envelope size selection screen shown in FIG. 6C, the CPU 201 determines that an envelope size has been selected. If it is determined by the CPU 201 that an envelope size has been selected, the process proceeds to a step S512. On the other hand, if it is determined by the CPU 201 that an envelope size has not been selected, the process returns to the step S507. In the step S512, the CPU 201 highlights the selected envelope size. Specifically, as the selected envelope size, the CPU 201 highlights the pressed button of the envelope size option buttons 610 to 615 (envelope size indicated by the pressed button). Note that FIG. 6C is a diagram showing the envelope size selection screen in a state in which the envelope size of 235×120 mm is selected and highlighted.

In a step S513, the CPU 201 determines whether or not the set button 617 has been pressed. When the set button 617 is pressed by the user in a state in which an envelope size has been selected and highlighted on the envelope size selection screen shown in FIG. 6C, the CPU 201 determines that the set button 617 has been pressed. If it is determined by the CPU 201 that the set button 617 has been pressed, the process proceeds to a step S514. On the other hand, if it is determined by the CPU 201 that the set button 617 has not been pressed, the process returns to the step S507. Therefore, unless it is determined that the set button 617 has been pressed, the CPU 201 receives an input of the setting guidance button 616 or one of the envelope size option buttons 610 to 615 on the envelope size selection screen shown in FIG. 6C, any number of times. In the step S514, the CPU 201 sets the envelope size being currently selected and highlighted, as the sheet size set for the sheet tray to be set, and stores the sheet setting information thereon in the storage section 203. After that, the process in FIG. 5 is terminated. With this, the sheet size setting for the sheet tray is terminated.

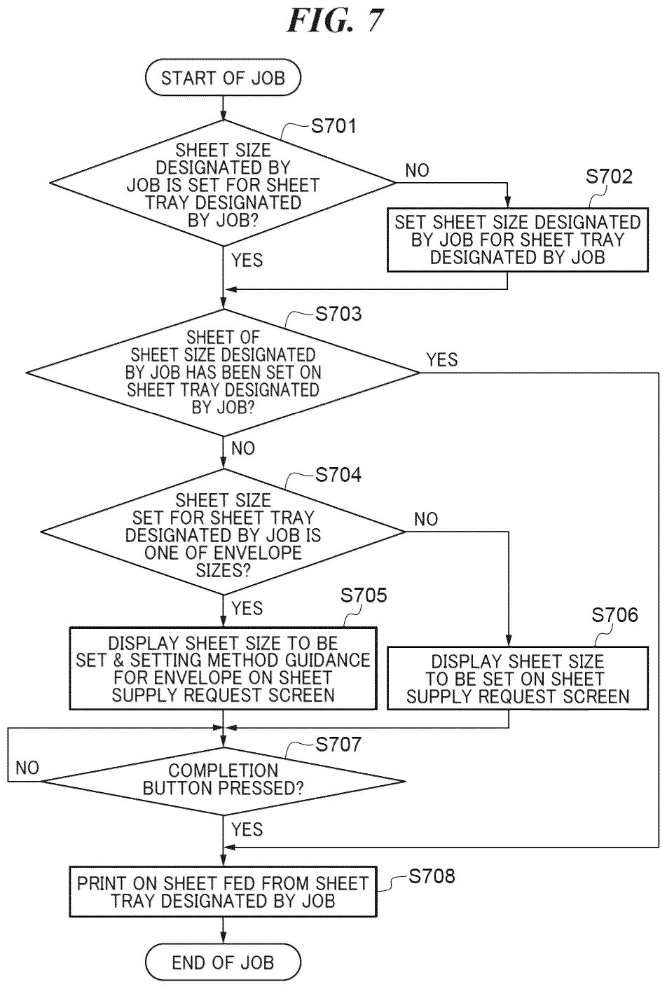

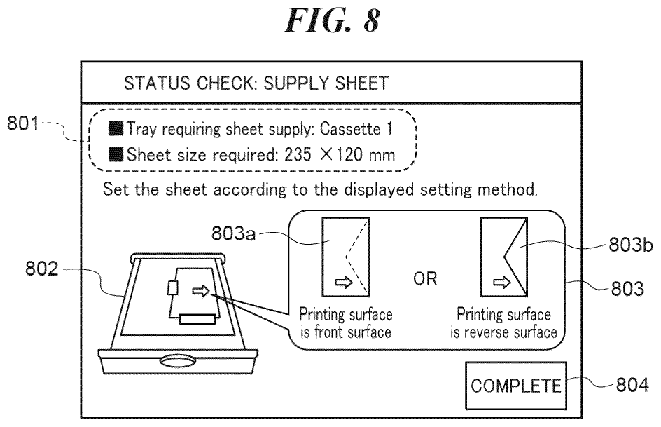

FIG. 7 is a flowchart of a process performed when the image forming apparatus 100 displays the setting method guidance for an envelope in a case where the user sets a sheet during execution of a print job. The process in FIG. 7, performed by the image forming apparatus 100, is a process performed after a print job has been input, in a case where a sheet has not been set on a sheet tray designated by the print job and the user sets a sheet in the middle of the print job. Note that the process performed by the image forming apparatus 100, shown in FIG. 7, (method of controlling the image forming apparatus) is realized by the CPU 201 (computer) that loads a program stored in the storage section 203 into the eMMC 202 and executes the loaded program. The process performed by the image forming apparatus 100 (process for displaying the setting method guidance for an envelope during execution of the print job), shown in FIG. 7, will be described below with reference to FIG. 8.

FIG. 8 is a diagram showing a sheet setting request screen as an example of a UI displayed when the setting method guidance for an envelope is displayed on the console section 207 during execution of a print job. Note that in the following description and the flowchart in FIG. 7, the print job is denoted as the “job”. The image forming apparatus 100 receives an input of a job from the user via the console section 207 or the external client 301. Thus, when the job is started, as shown in FIG. 7, in a step S701, the CPU 201 determines whether or not a sheet size designated by the job has been set for a sheet tray designated by the job. This determination is performed based on the sheet setting information stored in the storage section 203.

Note that designation of the sheet tray by the job can be performed by individual designation, such as designating a sheet tray itself, e.g. by “manual feed tray”, or by collective designation, such as designating sheet trays for one of which a sheet size designated by the job is selectively set, e.g. by “auto”. Further, in a case where designation of the sheet tray by the job is collective designation, there is a case where a corresponding sheet tray does not exist, but in this case, one of the sheet trays from which a sheet of the size designated by the job can be fed is selected as the sheet tray designated by the job.

If it is determined in the step S701 by the CPU 201 that the sheet size designated by the job has been set for the sheet tray designated by the job, the process proceeds to a step S703. On the other hand, if it is determined by the CPU 201 that the sheet size designated by the job has not been set for the sheet tray designated by the job, the process proceeds to a step S702. The case where the sheet size designated by the job has not been set for the sheet tray designated by the job includes a case where no sheet size has been set for the sheet tray designated by the job. Besides this, there is a case where a sheet size different from the sheet size designated by the job has been set for the sheet tray designated by the job. Note that in a case where the sheet size intended to be designated by the job is not a sheet size of a sheet which can be set on the sheet tray intended to be designated by the job, an error notification indicating this fact is displayed by the printer driver, at a stage where the sheet tray or the sheet size is designated. Therefore, when the job is executed, the sheet size designated by the job is a sheet size which can be set on the sheet tray designated by the job.

In the step S702, the CPU 201 (setting unit) sets the sheet size designated by the job for the sheet tray designated by the job. To do this, the CPU 201 sets the sheet size designated by the job as the sheet size to be set for the sheet tray designated by the job and stores the sheet setting information in the storage section 203.

In the step S703, the CPU 201 determines whether or not a sheet of the sheet size designated by the job has been set on the sheet tray designated by the job. This determination is performed based on detection information obtained by a sensor provided on the sheet tray. For example, in a case where the sensor can detect presence/absence of a sheet in the sheet tray and the sheet size, the determination in the step S703 is performed as follows: If a sheet is present in the sheet tray designated by the job, and the sheet size of this sheet coincides with the sheet size designated by the job, the CPU 201 determines that a sheet of the sheet size designated by the job has been set on the sheet tray designated by the job.

On the other hand, in a case where the sensor can detect only presence/absence of a sheet in the sheet tray, the determination in the step S703 is performed in the following manner: The CPU 201 sets a size change flag in the storage section 203 only in a case where the setting of the sheet size with respect to the sheet tray has been changed in the step S702. Then, if the sensor detects presence of a sheet in the sheet tray designated by the job and the size change flag is cleared, the CPU 201 determines that a sheet of the sheet size designated by the job has been set on the sheet tray designated by the job. Note that in a case where the size change flag is used, the CPU 201 necessarily clears the size change flag when the step S703 is terminated.

If it is determined by the CPU 201 that a sheet of the sheet size designated by the job has been set on the sheet tray designated by the job, the process proceeds to a step S708. Note that in this case, setting of a sheet is not required, and hence the setting method guidance for a sheet is not displayed to the user. With this, the image forming apparatus 100 can prevent unnecessary guidance from being displayed. On the other hand, if it is determined by the CPU 201 that a sheet of the sheet size designated by the job has not been set on the sheet tray designated by the job, the process proceeds to a step S704. Note that in this case, setting of a sheet on the sheet tray is required, and hence the setting method guidance for a sheet is sometimes displayed to the user depending on the sheet required to be set.

In the step S704, the CPU 201 determines whether or not the sheet size set for the sheet tray designated by the job is one of the envelope sizes. This determination is performed by the CPU 201 that checks the sheet size set for the sheet tray designated by the job from the sheet setting information stored in the storage section 203. Note that the contents of the sheet setting request screen to be displayed on the console section 207 next are determined according to a result of this determination. If it is determined by the CPU 201 that the sheet size set for the sheet tray designated by the job is one of the envelope sizes, the process proceeds to a step S705. On the other hand, if it is determined by the CPU 201 that the sheet size set for the sheet tray designated by the job corresponds to none of the envelope sizes, the process proceeds to a step S706.

In the step S705, the CPU 201 (display unit) displays the sheet setting request screen shown in FIG. 8 on the console section 207. On the sheet setting request screen shown in FIG. 8, information 801, an illustration 802 of the sheet tray requiring sheet setting, a speech balloon 803 for explaining how to set an envelope to be set, and a completion button 804 are displayed. The contents of the information 801 indicate a sheet tray requiring sheet setting and a size of the envelope to be set, and are acquired from the sheet setting information used in the determination in the step S704 but can be acquired from the job. The CPU 201 refers to the acquired sheet tray and size of the envelope, and the sheet information (information on setting methods of envelopes which can be set on the sheet trays of the image forming apparatus 100, shown in FIGS. 4A and 4B) stored in the storage section 203, and determines the explanation contents indicated in the speech balloon 803.

The explanation contents presented in the speech balloon 803 can be presented by illustrations, such as illustrations 803a and 803b, or can be each presented by a sentence or a combination of a sentence and an illustration. Further, the explanation contents presented in the speech balloon 803 include information for enabling determination of whether or not the envelope is properly set by the user, concerning each of the case where the user desires to perform printing on the front surface and the case where the user desires to perform printing on the reverse surface. This information includes information on a position of the flap (whether the flap is at a long side or a short side of the envelope), an opened/closed state of the flap, which of the reverse surface or front surface of the envelope faces upward, which of sides of the envelope is the leading edge side in the conveying direction, and so forth. Here, as mentioned above, a surface on which an address is generally written is defined as the front surface, and a surface opposite to the front surface is defined as the reverse surface.

FIG. 8 shows the sheet setting request screen in a case where the sheet tray designated by the job is the cassette 1 and the sheet size designated by the job is 235×120 mm. The user is enabled to easily set the envelope by the correct method, by setting the envelope on the sheet tray designated by the job through referring to the speech balloon 803 and the like on the sheet setting request screen shown in FIG. 8. Thus, the guidance about how to set a sheet of the sheet size designated by the job on the sheet tray designated by the job is displayed on the sheet setting request screen shown in FIG. 8 as the display of the setting method guidance for an envelope. At this time, in the speech balloon 803, all of the setting methods by which the envelope of 235×120 mm as the sheet size designated by the job can be set on the cassette 1 as the sheet tray designated by the job are displayed as presented by the illustrations 803a and 803b (see FIGS. 4A and 4B). With this, the image forming apparatus 100 can present all displays of the setting method guidance for an envelope to the user at once.

A button for switching the printing surface, such as the reverse side printing button 632 appearing in FIG. 6E, can be made available on the sheet setting request screen shown in FIG. 8, and the illustrations 803a and 803b can be switchingly displayed according to an input of the user using this button. In this case, the explanation contents presented in the speech balloon 803 are switchingly displayed, and hence this is useful when the display of the explanation contents presented in the speech balloon 803 cannot be completed on one screen.

Further, in the present embodiment, the setting method guidance for an envelope display is directly displayed on the sheet setting request screen shown in FIG. 8. However, on the sheet setting request screen shown in FIG. 8 in a state in which the speech balloon 803 is not presented, the same operation button (reception unit) as the setting guidance button 616 appearing in FIG. 6C can be made available, and the screen can be shifted to the screen of the speech balloon 803 when the user presses this operation button. In this case, the CPU 201 displays the setting method guidance for an envelope, upon receipt of display instruction from the user via the above-mentioned operation button. With this, the user can intentionally cause the image forming apparatus 100 to display or not to display the setting method guidance for an envelope. Note that as means for receiving the display instruction from the user, not only the above-mentioned operation button (i.e. the button displayed on the touch panel of the console section 207), but also a hard key of the console section 207, to which the function of receiving the display instruction from the user is applied, can be used. Further, the CPU 201 can receive the display instruction from the user via the external client 301.

In the step S706, the CPU 201 displays the sheet setting request screen shown in FIG. 8 on the console section 207. However, in this case, the information 801 and the completion button 804 are displayed, but the illustration 802 of the sheet tray requiring sheet setting and the speech balloon 803 for explaining how to set the envelope to be set are not displayed. Note that the contents of the information 801 indicate the sheet tray requiring sheet setting and the size of the sheet to be set, and are acquired from the sheet setting information used in the determination in the step $704 but can be acquired from the job. Thus, in a case where the sheet size set for the sheet tray designated by the job corresponds to none of the envelope sizes, the guidance about the setting method which makes it possible to set a sheet of the sheet size designated by the job on the sheet tray designated by the job is not displayed. That is, the sheet setting method guidance is not displayed.

In a step S707, the CPU 201 determines whether or not the completion button 804 has been pressed. When the user completes the sheet setting operation as designated by the job and further presses the completion button 804 on the sheet setting request screen shown in FIG. 8, the CPU 201 determines that the completion button 804 has been pressed. Note that the CPU 201 can detect that the user has completed the sheet setting operation designated by the job based on detection information obtained by a sensor provided on the sheet tray. If it is determined by the CPU 201 that the completion button 804 has not been pressed, the process returns to the step S707.

On the other hand, if it is determined by the CPU 201 that the completion button 804 has been pressed, the process proceeds to the step S708. At this time, the CPU 201 closes the sheet setting request screen shown in FIG. 8 on the console section 207. In the step S708, the CPU 201 provides a print instruction to the image forming section 104 via the printer I/F 206 to perform printing on the sheet fed from the sheet tray designated by the job. After that, when the image forming section 104 completes the printing, the process in FIG. 7 is terminated. With this, the job is terminated.

As described above, in the image forming apparatus 100 according to the present embodiment, the sheet information in which the setting methods which make it possible to set a sheet on a sheet tray are associated with each tray is stored in the storage section 203 with respect to the envelopes each of which can be set on the sheet tray by a plurality of methods (see FIGS. 4A and 4B). Further, the CPU 201 of the image forming apparatus 100 sets a sheet size of a sheet which can be set on a sheet tray designated by a job, which is designated by the job, for the sheet tray designated by the job (step S702). Further, in a case where the sheet size set for the sheet tray designated by the job is a sheet size of an envelope, the CPU 201 displays the setting method guidance for an envelope, based on the sheet size set for the sheet tray designated by the job and the sheet information. With this, the CPU 201 displays the guidance about a setting method which makes it possible to set a sheet of the sheet size designated by the job on the sheet tray designated by the job (step S705). Thus, the image forming apparatus 100 can properly display the setting method which makes it possible to set a sheet on the sheet tray designated by the job with respect to the envelope which can be set on the sheet tray by a plurality of methods.

Further, as described above, since the envelope as one of specific sheets is set on the sheet tray by a plurality of methods, display of the setting method guidance for an envelope is useful. However, as for a sheet which has neither a positive position nor an opposite position with respect to a setting orientation, i.e. a sheet which is different from the specific sheet, such as plain paper, if the sheet setting method guidance is displayed whenever printing is performed, the contents displayed on the console section 207 are made complicated, and this is not desirable. In this respect, in a case where the sheet size set for the sheet tray designated by the job is a sheet size of a sheet other than the envelope, the setting method guidance for a sheet is not displayed (step S706). Thus, the image forming apparatus 100 prevents the contents displayed on the console section 207 from being made complicated.

The present invention has been described heretofore based on the embodiment thereof. However, the present invention is not limited to the above-described embodiment, but a variety of variations and modifications are possible without departing from the spirit and scope thereof. In the present embodiment, to make explanation easier to understand, the description has been given of the example in which the sheet for which the setting method guidance is displayed is limited to the envelope. However, the present invention can be applied to any sheet which can be set on the sheet tray by a plurality of methods. For example, there is a case where even when a sheet designated as an object to be set on a sheet tray to be set is a sheet other than the envelope, the sheet print information concerning this sheet is stored in the storage section 203, due to the sheet regarded as a sheet needed to display the setting method guidance. In this case, the CPU 201 refers to the setting methods which make it possible to set a sheet on the sheet tray associated with the sheet tray to be set, from the sheet information stored in the storage section 203, and displays a proper setting method guidance screen.

Further, in the present embodiment, as described above, the envelope is described as an example of a sheet for which the setting method guidance is displayed. However, the present invention can be applied not only to the envelope, but also to any other sheet insofar as it is a specific sheet which can be set on the sheet tray by a plurality of methods. Examples of the specific sheet other than the envelope, which can be set on the sheet tray by a plurality of methods, include a postcard. Note that in the case of the postcard, the information for enabling determination of whether or not the postcard is properly set by the user, includes, for example, a setting orientation and a front/reverse surface with reference to a position where a stamp is put.

Further, in the present embodiment, to prevent the process from being made complicated, description of an alternative process is omitted which is to be executed in a case where the setting of a sheet size for the sheet tray or a job is cancelled. For the same reason, description of an alternative flow is omitted which is to be executed e.g. in a case where a mismatch between a sheet size set for the sheet tray and a sheet size of an actually set sheet is detected. Note that in the present embodiment, similar to the conventional sheet tray setting procedure and the procedure of setting a sheet during execution of a job, these alternative processes can also be executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application NO. 2023-155923 filed Sep. 21, 2023, which is hereby incorporated by reference herein in its entirety.

What is claimed is:

1. An image forming apparatus that stores sheet information in which setting methods are associated with each sheet tray, wherein a sheet corresponding to the sheet information is a specific sheet which can be set on a sheet tray by a plurality of methods, comprising:
at least one processor; and
a memory coupled to the at least one processor storing instructions that, when executed by the processor, cause the processor to function as:
a setting unit configured to set a sheet size for the sheet tray designated by a print job, wherein the sheet size of a sheet which can be set on the sheet tray designated by the print job is a sheet size designated by the print job; and
a display unit configured to display, in a case where a specific sheet size of the specific sheet is designated by the print job, a guidance about a setting method which makes it possible to set the specific sheet of the specific sheet size on the sheet tray designated by the print job, based on the specific sheet size and the sheet information.

2. The image forming apparatus according to claim 1, wherein in a case where no sheet size is set for the sheet tray designated by the print job, the operation of the setting unit is executed.

3. The image forming apparatus according to claim 1, wherein in a case where the sheet size set for the sheet tray designated by the print job is different from the sheet size designated by the print job, the operation of the setting unit is executed.

4. The image forming apparatus according to claim 1, wherein in a case where a sheet of the sheet size designated by the print job has not been set on the sheet tray designated by the print job, the display unit displays the guidance.

5. The image forming apparatus according to claim 1, wherein the display unit displays the guidance according to a display instruction from a user.

6. The image forming apparatus according to claim 5, wherein the processor is caused to also function as a reception unit configured to receive a display instruction from the user.

7. The image forming apparatus according to claim 1, wherein the display unit displays all of setting methods which make it possible to set a sheet of the sheet size designated by the print job on the sheet tray designated by the print job, on the guidance display.

8. The image forming apparatus according to claim 1, wherein the specific sheet is an envelope.

9. The image forming apparatus according to claim 1, wherein the specific sheet is a postcard.

10. The image forming apparatus according to claim 1, wherein in a case where the sheet size set for the sheet tray designated by the print job is a sheet size of a sheet different from the specific sheet, the display unit does not display the guidance.

11. A method of controlling an image forming apparatus that stores sheet information in which setting methods are associated with each sheet tray, wherein a sheet corresponding to the sheet information is a specific sheet which can be set on a sheet tray by a plurality of methods, comprising:
setting a sheet size for the sheet tray designated by a print job, wherein the sheet size of a sheet which can be set on the sheet tray designated by the print job is a sheet size designated by the print job; and
displaying, in a case where a specific sheet size of the specific sheet is designated by the print job, a guidance about a setting method which makes it possible to set the specific sheet of the specific sheet size on the sheet tray designated by the print job, based on the specific sheet size and the sheet information.

12. A non-transitory computer-readable storage medium storing a program for causing a computer to execute a method of controlling an image forming apparatus that stores sheet information in which setting methods are associated with each sheet tray, wherein a sheet corresponding to the sheet information is a specific sheet which can be set on a sheet tray by a plurality of methods,
wherein the method comprises:
setting a sheet size for the sheet tray designated by a print job, wherein the sheet size of a sheet which can be set on the sheet tray designated by the print job is a sheet size designated by the print job; and
displaying, in a case where a specific sheet size of the specific sheet is designated by the print job, a guidance about a setting method which makes it possible to set the specific sheet of the specific sheet size on the sheet tray designated by the print job, based on the specific sheet size and the sheet information.
